(19) United States
(12) Patent Application Publication
(10) Pub. No.: US 2013/0196585 A1
(43) Pub. Date: Aug. 1, 2013

(54) JOINT CONSTRUCTION, VENTILATION ARM AND VENTILATION SYSTEM

(71) Applicant: Lars Hedlund, Skelleftea (SE)

(72) Inventor: Lars Hedlund, Skelleftea (SE)

(73) Assignee: FUMEX AB, Skelleftea (SE)

(21) Appl. No.: 13/821,223

(22) PCT Filed: Sep. 6, 2011
(86) PCT No.: PCT/SE11/51075

§ 371 Date: Mar. 6, 2013

(30) Foreign Application Priority Data
Sep. 10, 2010 (SE) 1050939-6

(51) Int. Cl. B08B 15/04; F16L 27/00

(52) U.S. Cl. CPC B08B 15/04; F16L 27/00
USPC 454/63; 285/144.1

(57) ABSTRACT

This invention concerns a joint construction 1 intended to be used between two extended tubes 2 and 3 in order to connect these tubes 2 and 3 with each other and where the joint construction 1 offers an open internal compartment 4 that, during use of the joint construction 1, is connected to the open inner compartments 5 and 6 of the relevant tube element. The joint construction 1 comprises a first joint half 7 and a second joint half 8 that are essentially identical, an arrangement 9 that holds the joint halves 7 and 8 and thus the joint construction 1 together and where the joint halves 7 and 8 each comprise a first part 12 and 13 and a second part 14 and 15. The first parts 12 and 13 make possible a connection of the relevant joint half 7 and 8 to one of the tubes 2 and 3. The second parts 14 and 15 of each joint half 7 and 8 face each other and comprise outermost free end parts 20 and 21 that are directed towards each other, have a circular form and can be rotated relative to each other around a common axis X. A sealing and glide arrangement 22 located between the end surfaces 23 and 24 of the outermost free edge parts and comprising two surfaces 26 and 27 that make contact with the relevant end surface 23 and 24. At least one of the end surfaces 23 and 24 of the outermost free edge parts of the second parts comprises a construction 25 that increases friction that functions between the end surface 23 and/or 24 and the side surface 26 and/or 27 of the sealing and glide arrangement 22 that makes contact with the end surface 23 and/or 24. The invention also concerns a ventilation arm 29 and ventilation system 32.

### TECHNICAL FIELD

This invention concerns a joint construction intended to be used in a ventilation system, a ventilation arm comprising such a joint construction and a ventilation system comprising a ventilation arm comprising such a joint construction.

### BACKGROUND

Ventilation systems of different types are used to ventilate various compartments. Ventilation systems comprise air-extraction arrangements and are used to transport away undesired air-borne particles and substances, air-borne contaminants, in various types of environment, normally various work environments. One example is the type of ventilation system that is used in laboratories, during assembly work, or during other types of work. A simple description of such a ventilation system is that it comprises an air-transport channel, an air-extraction unit at one end of the channel and an extraction mouthpiece at the second end of the channel, which is arranged at the source of the contamination or at a region that it is desired should be kept free of contaminants.

Such a ventilation system often comprises a ventilation arm that constitutes a part of the air-transport channel, the part that is located closest to the source of contamination or the region that is to be held free of contaminants. The ventilation arm in turn comprises arm components that are connected to each other in such a manner that they can be bent, and their positions relative to each other can be adjusted, such that the extraction mouthpiece arranged at the outermost free end of the ventilation arm can be placed in the region of interest, where the contaminant is present or where it is not desired. The rear part of the arm is connected to the air-transport channel, to tubes or lines or to both tubes and lines through which the air is transported away.

The arm components normally comprise tubes connected to each other through various joint constructions and various types of balancing system in the form of, for example, spring arrangements connected to the tubes or joint constructions, or to both.

There is a risk that these balancing systems act as obstructions during use of the ventilation arm.

Long balancing systems that are attached to different tubes on each side of a joint function well in certain positions, while in other positions they act as obstructions to the ventilation arm, the mobile arm components, the tubes or the joints. It is alternatively possible that the joints, or one or more tubes in the vicinity of the joint, act as obstructions for the balancing system. In cases in which the balancing system comprises a spring or a spring-like construction, there is a risk that it ceases to function when it is broken by the joints or by tubes in the vicinity of the joint. Rotation at the joints, in order to obtain displacement of the tube elements relative to each other, entails too large a displacement of one of the attachment points of the balancing system in the ventilation arm. This leads to the ventilation arm becoming locked in certain positions, or taking up a position at which the balancing system no longer functions in the desired manner, and in which it can no longer offer the desired function.

Friction joints have started to be used in order to avoid the use of these balancing systems. Such a joint comprises two joint halves that are connected to each other and where each joint half is connected to a tube. Each joint half comprises a radial surface that lies in contact with the surface of the other joint half and where the joint halves rotate relative to each other in such a manner that the surfaces of the joint halves glide against each other. A force of friction arises between the surfaces that balances the joint and its motion.

This force of friction, however, is not sufficient for ensuring with a sufficient margin of safety the desired motion and stationary conditions of the joint, and therewith of the ventilation system, nor is it sufficient to ensure access to the region of interest.

### DESCRIPTION OF THE INVENTION

One purpose of this invention is to offer a joint construction, a ventilation arm and a ventilation system that make it possible to obtain the desired motion and stationary conditions, and access to the region of interest.

This purpose is achieved with a joint construction having the characteristics that are specified in the characterising part of claim 1, a ventilation arm according to claim 10, and a ventilation system according to claim 12.

### BRIEF DESCRIPTION OF DRAWINGS

FIG. 1 shows a joint construction according to the invention connected to two tubes.

FIG. 2 shows an open joint construction according to the invention connected to two tubes.

FIG. 3 shows a view in detail of a joint construction according to the invention.

FIG. 4 shows a further view in detail of a joint construction according to the invention.

FIG. 5 shows a further view in detail of a joint construction according to the invention.

FIG. 6 shows a ventilation arm according to the invention.

FIG. 7 shows a ventilation arrangement according to the invention.

### DETAILED DESCRIPTION OF EMBODIMENTS

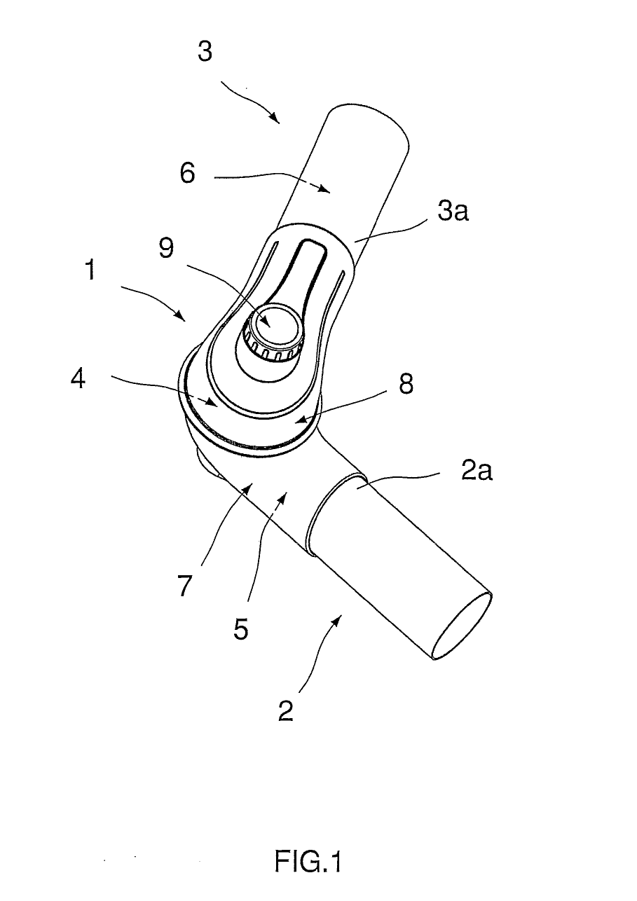

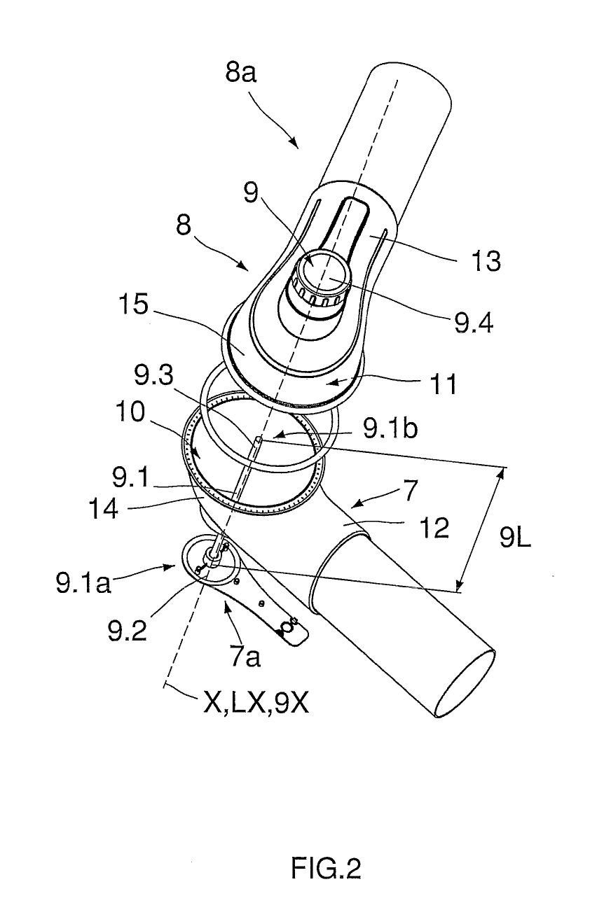

A joint construction 1 according to the invention is a friction joint that, when in use, is to be arranged between and connected to two extended tubes 2 and 3. The joint construction 1 offers an open internal compartment 4 that, when the joint construction is in use, constitutes a connection between the two tubes 2 and 3 and between their open internal compartments 5 and 6. See FIGS. 1 and 2.

The air that is to be removed, the air that carries with it air-borne particles and substances, contaminants, that are to be transported from one defined region, normally a working region, to a second region, normally a collection region, possibly comprising also purification equipment, passes through the joint construction 1 and the two tubes 2 and 3, through the compartments 4-6.

The joint construction 1 connects these two tubes 2 and 3 with each other. The joint construction 1 has also such a design that makes possible the positional adjustment of the tubes 2 and 3, relative to each other.

The joint construction 1 comprises a first joint half 7 and a second joint half 8 that are essentially identical and connected to each other and to one of the tubes 2 and 3. The two joint halves 7 and 8 are held together against each other with the aid of an arrangement 9. See FIGS. 1 and 2.

Each joint half 7 and 8 has the principal form of a circularly formed body with inner surfaces that direct and facilitate the passage of air through the joint construction 1. It is appropriate that the joint construction 1 be manufactured from a plastic material or a composite material, and that it be formed in a manner that is suitable for these materials.

The two joint halves 7 and 8 together form the external and internal forms of the joint construction. The inner compartment 4 of the joint construction is formed and limited by the internal compartments 10 and 11 of the relevant joint half.

Each joint half 7 and 8 comprises a first part 12 and 13 and a second part 14 and 15. Each of the first parts 12 and 13 comprises a first opening 16 and 17. The first parts 12 and 13 and the openings 16 and 17 on each joint half 7 and 8 each make possible a connection of the relevant joint half 7 or 8 to one of the tubes 2 or 3. The end sections 2a and 3a of the tubes are inserted into the relevant opening 16 and 17, and they are mounted fixed in the relevant joint half 7 and 8. See FIG. 2.

Each of the second parts 14 and 15 comprises a second opening 18 and 19. The second parts 14 and 15 and the second openings 18 and 19 on each joint half 7 and 8 are turned towards each other. The second parts 14 and 15 comprise outermost free end parts 20 and 21 that are directed towards each other.

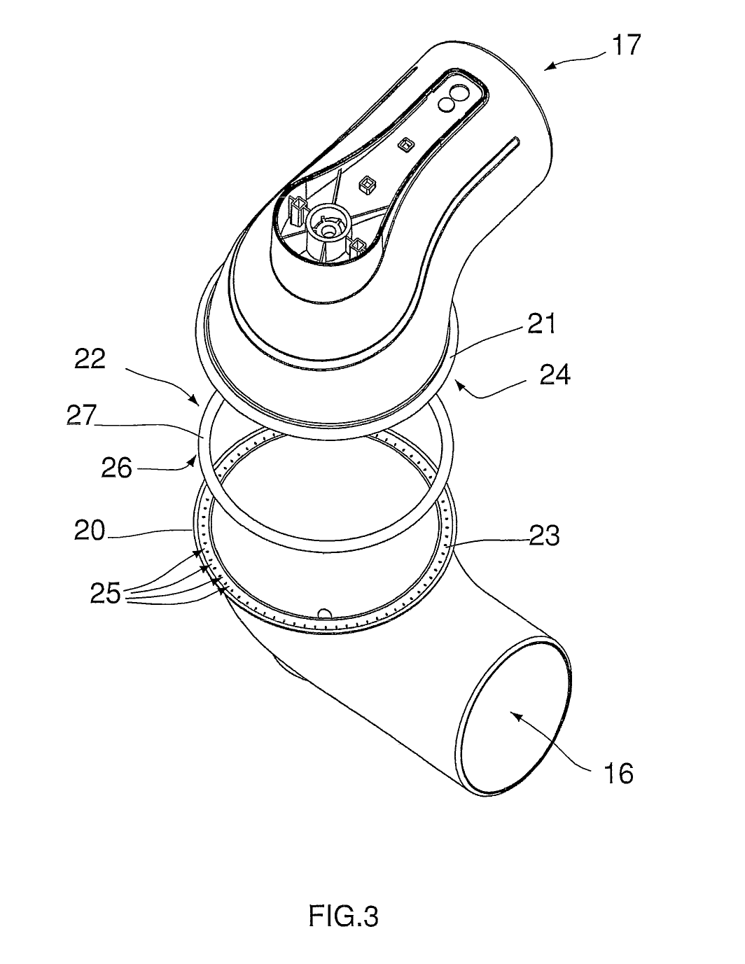

The joint construction 1 comprises also a sealing and glide arrangement 22 located between the free end parts 20 and 21 that are directed towards each other. Each of the outermost free end parts 20 and 21 comprises an end surface 23 and 24, while the sealing and glide arrangement 22 is arranged such that it makes contact with these end surfaces 23 and 24. The end surfaces 23 and 24 constitute a bottom part of an indentation, and it is appropriate that this indentation be relatively shallow, in the outermost free end part 20 and 21 of the relevant part of the joint. See FIGS. 2-5.

The outermost free end parts 20 and 21, the end surfaces 23 and 24 and the sealing and glide arrangement 22 are all circular and ring-shaped, in the shape of their ends that provide surfaces, their cross-sectional area, in those planes in which the parts are directed towards and in contact with each other. This results in it being possible to rotate the joint halves 7 and 8 relative to each other around a common axis X, which constitutes also the central axis LX of the joint construction, without this giving rise to any change in shape of the joint construction 1 that risks causing leakage, the leakage of air. It is such a rotation of the two joint halves 7 and 8 relative to each other that results in a change in position of the two tubes 2 and 3 that are connected to each other through the joint construction.

In order for it to be possible for the joint construction 1 to offer a distinct termination of motion between the two joint halves 7 and 8, the end surfaces 23 and 24 of the outermost free parts comprise a construction 25 that increases friction and that acts between the relevant end part 20 and 21, the end surface 23 and 24, and the sealing and glide arrangement 22. This termination of motion due to the construction 25 that increases friction means that the locations of the tube elements relative to each other will be the desired locations as soon as an influenced, actuating, tube moving, force on one of the tubes 2 or 3 or one of the joint halves 4 or 5, or both one of the tubes and one of the joint halves, is removed. As long as this actuating force is large and overcomes friction, the joint halves 7 and 8 are turned relative to each other, but when the actuating force becomes smaller than the friction, the joint halves 7 and 8 become fixed in the positions relative to each other. See FIGS. 2-5.

The sealing and glide arrangement 22 comprises two opposing side surfaces 26 and 27 that make contact with the relevant end surface 23 and 24 and the construction 25 that increases friction. The construction 25 that increases friction is present at the end part, the end surface, of at least one joint half.

The construction 25 that increases friction comprises an unevenness on the end surface either 23 or 24, or both 23 and 24, in the plane of extent A of the surface. The construction 25 that increases friction, the unevenness, is unstructured, and is randomly formed across the end surface. It may be formed in at least one of the end surfaces 23 and 24 during the manufacture of the relevant joint half 7 and 8, or it may constitute a unit that is applied to the end surface.

The construction 25 that increases friction, the unevenness, may also have a structure that has a definite form and is distributed over the end surface. Also this construction 25 that increases friction may be formed in at least one of the end surfaces 23 and 24 during the manufacture of the relevant joint half 7 and 8, or it may constitute a unit that is applied to the end surface.

The construction 25 that increases friction comprises elevations 28 of material in or on at least one edge part 15 or 16 of the joint half, on the end surface of the edge part 15a or 16a.

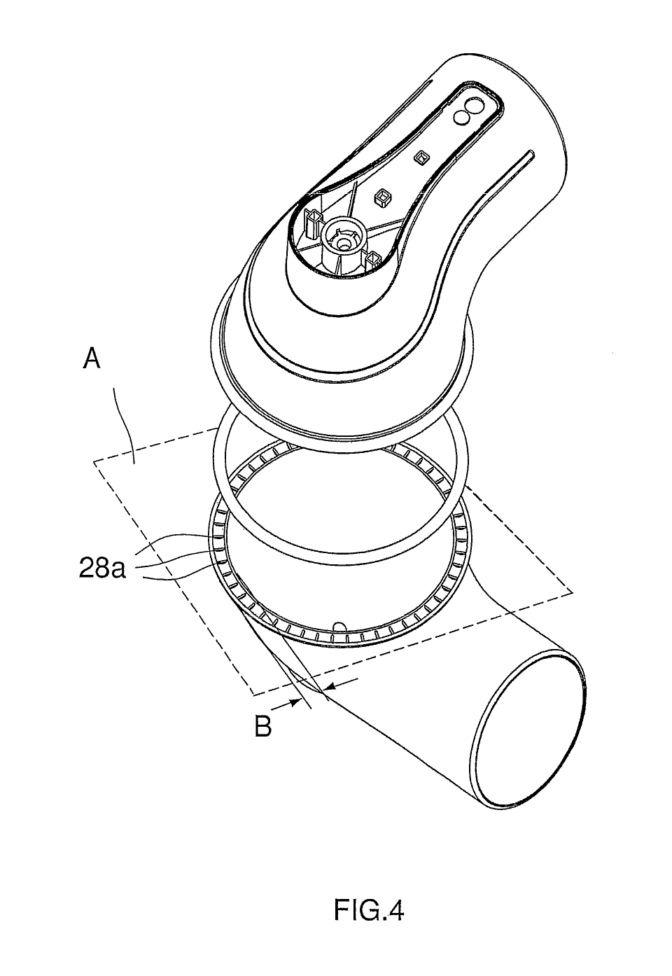

The elevations 28 of material are extended elevations 28a, ridges, that are arranged with their longitudinal extension in the radial direction relative to the axis of rotation X of the joint halves. The elevations of material 28, the extended elevations 28a, the ridges, extend across the full width B of the end surface. See FIG. 4.

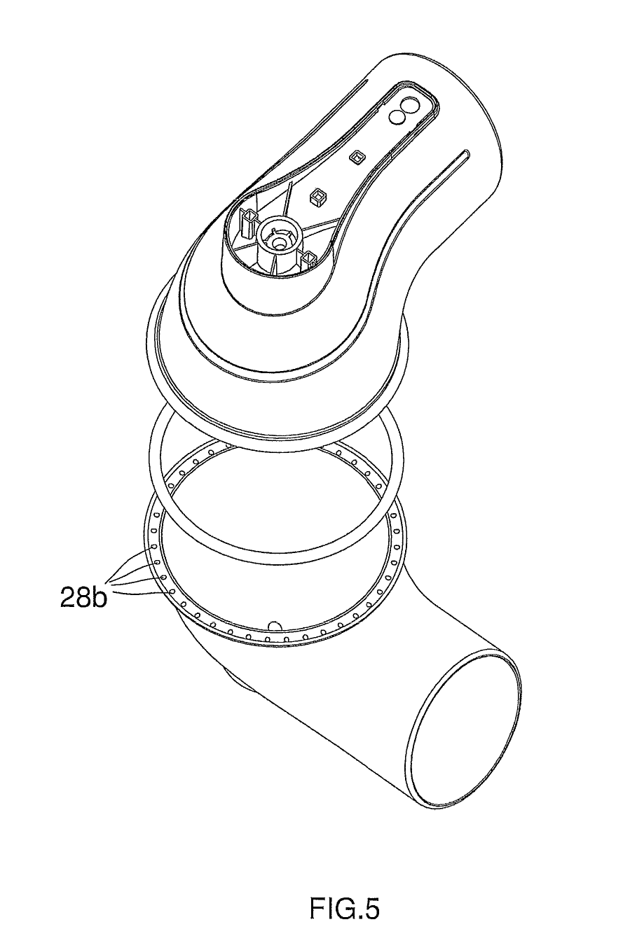

The elevations 28 of material may comprise also point elevations 28b distributed across at least one end surface 23 and 24 of the edge part. See FIG. 5.

The joint halves 7 and 8 are held together with the aid of the arrangement 9. The arrangement 9 acts on and between the two joint halves 7 and 8. The arrangement 9 comprises an extended fixture element, an axial element 9.1. The axial element 9.1 has a design similar to that of a bolt that passes through the complete joint construction 1, from one joint half 7 through the open inner compartment 4, or 5 and 6, in the joint construction 1 to the second joint half 8. See FIG. 2.

The axial element 9.1 comprises a headlike construction 9.2 at one of its ends 9.1a and a fixture part 9.3, that comprises, for example, an outer thread, at its second end 9.1b that makes it possible to mount a fixture fitting 9.4, for example a nut-like construction with an internal thread, onto the axial element 9.1 and the fixture part 9.3, and thus to influence the active length 9L of the axial element, which in turn makes it possible to place the two joint halves 7 and 8 under tension in contact with each other with a variable force.

The headlike construction 9.2 is arranged at the outer surface of the first joint half 7a, or it may be integrated with or in the joint half 7. The arrangement 9, the headlike construction 9.2, may also be arranged on the outer surface 8a of the second joint half. What is important is that the axial element 9.1 passes through the joint construction 1 and holds the joint halves 7 and 8 together.

The fixture fitting 9.4 may be a nut, a knurled knob, or similar. The fixture fitting 9.4 may also make possible tightening with a tightening torque that has been determined in advance, through, for example, a pre-determined length of thread, a stop peg on one of the interacting parts, or similar.

The longitudinal axis 9X of the axial element coincides with the central axis LX of the joint construction. The rotation of the two joint halves 7 and 8 relative to each other takes place around this axis X of rotation, around the central axis LX of the joint construction and also around the longitudinal axis 9X of the axial element, since all of these axes coincide with each other.

The tube-shaped elements 2 and 3 may be circular when seen in section, or they may be oval, have sharp corners or have another form that results in good function for the flow of air.

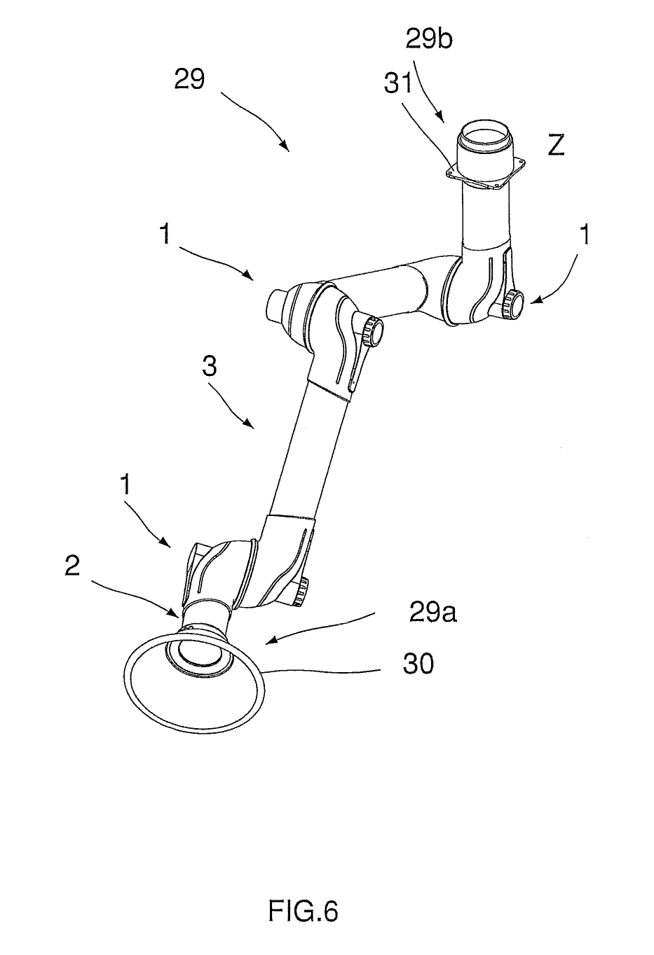

A ventilation arm 29 according to the invention comprises at least one joint construction 1 arranged between and connected to two extended tubes 2 and 3. Each tube 2 comprises a first end 5.1 and a second end 5.2 directed towards and united with a joint construction 6. The ventilation arm 29 comprises also an extraction hood 30 and a mounting arrangement 31. See FIG. 6.

The extraction hood 30 is arranged at the end of the ventilation arm 29, at its free forward end 29a, and it facilitates the capture of air, the contaminant, that it is desired to transport away from a defined region Y.

The mounting arrangement 31 makes it possible to mount the ventilation arm 29 on some form of structure in a room that will support the ventilation arm 29 when it is in use. The structure may be some form of supporting, bearing construction, such as a roof, a wall, a trolley, a framework, or similar. The mounting arrangement 31 is located at the rear, inner, upper part 29b of the ventilation arm.

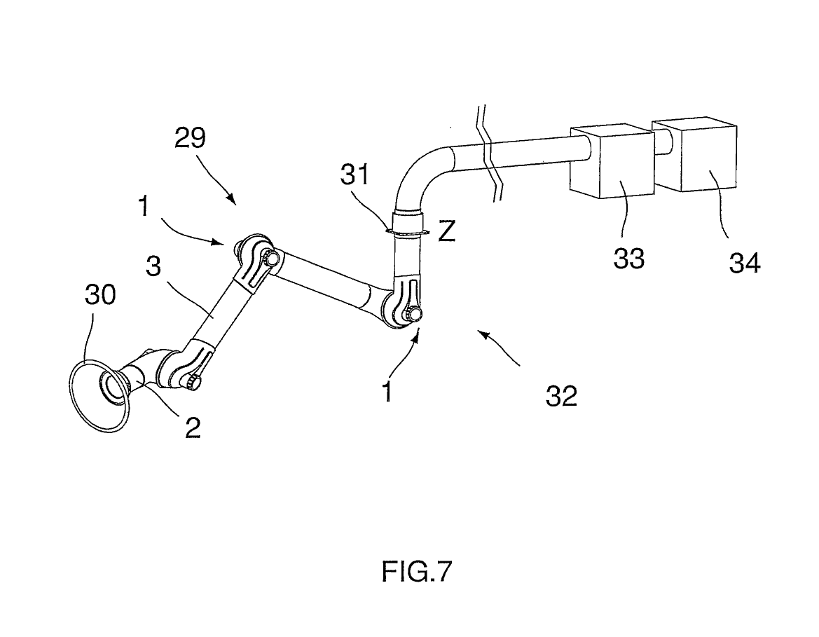

A ventilation system 32 according to the invention comprises at least one ventilation arm 29 corresponding to the one described above that in turn comprises at least one joint construction. The ventilation system 32 comprises also an air-extraction arrangement 33 that creates negative pressure in the ventilation arm 29, creates an extraction force in all air-carrying parts that transports away undesired air-borne particles and substances, air-borne contaminants, of various types from a defined region Y to an arrangement 34 in which the air is processed. See FIG. 7.

This description of different embodiments of the invention and alternative designs of its items is not to be seen as a limitation of the invention: it is to be interpreted in its broadest meaning in order not to limit unnecessarily the protective scope according to the attached patent claims. Changes that lie within the expertise of a person skilled in the arts lie within the protective scope of the innovative concept. The various designs of items that are given in the description above can be used and combined freely, as long as the desired function is obtained.

1. A joint construction intended to be used between two extended tubes in order to connect these tubes with each other and where the joint construction offers an open internal compartment that, during use of the joint construction, is connected to the open inner compartments of the relevant tube element,
comprising
a first joint half and a second joint half that are essentially identical and an arrangement that holds the joint halves and thus the joint construction together and where the joint halves each comprise a first part and a second part where the first parts make possible a connection of the relevant joint half to one of the tubes,
where the second parts of each joint half face each other and comprise outermost free end parts that are directed towards each other, have a circular form and can be rotated relative to each other around a common axis, and further comprising a sealing and glide arrangement located between the end surfaces of the outermost free edge parts and comprising two surfaces that make contact with the relevant end surface
characterised in that
at least one of the end surfaces of the outermost free edge parts of the second parts comprises a construction that increases friction that functions between the end surface and the side surface of the sealing and glide arrangement that makes contact with the end surface.

2. The joint construction according to claim 1, where the construction that increases friction is obtained in that the end surface is uneven across its plane of extent.

3. The joint construction according to claim 2, where the end surface is formed in an unstructured, random manner.

4. The joint construction according to claim 2, where the end surface is formed in a structured, pre-determined and controlled manner.

5. The joint construction according to claim 1, where the construction that increases friction comprises elevations of material on at least one end surface of the joint half.

6. The joint construction according to claim 5, where the elevations of material comprise extended elevations.

7. The joint construction according to claim 6, where the extended elevations are arranged with their longitudinal extents in the radial direction relative to the axis of rotation of the joint halves.

8. The joint construction according to claim 7, where the extended elevations extend across the complete width of the end surface.

9. The joint construction according to claim 5, where the elevations of material comprise point elevations distributed across the end surface of the edge part.

10. A ventilation arm comprising two tubes that are connected to each other with the aid of a joint construction according to claim 1, and an air-extraction hood arranged at the free end of the ventilation arm, which free end is located in a defined region from which it is desired that undesired air-borne particles and substances, air-borne contaminants, be transported.

11. The ventilation arm according to claim 10, comprising a mounting arrangement that makes possible the mounting of the ventilation arm to a supporting structure that supports the ventilation arm in a room.

12. A ventilation system comprising a ventilation arm according to claim 10 and an air-extraction arrangement that creates negative pressure in the ventilation arm that transports undesired air-borne particles and substances, airborne contaminants, of various types away from a defined region.
